(19) United States
(12) Patent Application Publication
(10) Pub. No.: US 2003/0095739 A1
(43) Pub. Date: May 22, 2003

(54) Fiber optic switch

(75) Inventors: Gerald H. Kim, Gilbert, AZ (US); Wesley R. Barcalow, Redmond, WA (US); David A. Beecher, Redmond, WA (US); Kelly K. Hayase, Snohomish, WA (US); Victor N. Lukyanchenko, Lynnwood, WA (US); Spencer G. Nelson, Bothell, WA (US); Lonnie J. Plenert, Bothell, WA (US); Joseph D. Ridge, Sammamish, WA (US); Steven M. Swedenburg, Bothell, WA (US); Nikolaos D. Xydas, Bothell, WA (US); Jackson Chao, Seattle, WA (US); Shane M. Rowell, Kirkland, WA (US); Paul Erik Zoba, Woodinville, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Bainbridge Networks, Inc.

(21) Appl. No.: 10/217,346

(22) Filed: Aug. 9, 2002

Related U.S. Application Data
(60) Provisional application No. 60/311,380, filed on Aug. 9, 2001.
(60) Provisional application No. 60/355,892, filed on Feb. 11, 2002.
(60) Provisional application No. 60/359,641, filed on Feb. 26, 2002.

(51) Int. Cl. G02B 6/35

(52) U.S. Cl. 385/17; 385/33

(57) ABSTRACT

A fiber optic switch includes a plurality of optical modules that selectively direct light between optical fibers. Each optical module includes an optical fiber, and a light beam steering mechanism for directing light from or to an optical fiber. A processor within the optical module, and an optical detector form a control circuit such that each optical module can align light from fibers within the optical switch. In one embodiment, the beam steering mechanism includes one or more piezoelectric motors that position lenses in front of an optical fiber. The capacity of the fiber optic switch can be increased or decreased by adding or removing optical modules from the switch.

### CROSS-REFERENCES TO RELATED APPLICATIONS

The present application is related to U.S. Provisional Application No. 60/311,380 filed Aug. 9, 2001; No. 60/355,892 filed Feb. 11, 2002; and No. 60/359,641 filed Feb. 26, 2002, the benefit of the filing dates being claimed under 35 U.S.C. §119(e).

### FIELD OF THE INVENTION

The present invention relates to switches for transmitting light between optical fibers.

### BACKGROUND OF THE INVENTION

As optical fibers replace conventional copper wires for transporting high volumes of communication and other data signals, there is a need for high speed switches that can effectively route these signals. In the past, such switches have most commonly been electrically based. That is, the optical signals transmitted on the fibers are converted to an electrical form and routed through a switch before being reconverted back to an optical form and delivered into another optical fiber. Such electrical switches are generally complex and inefficient because the signals must be changed from an optical to electrical form and back at each switching point.

In an all optical switch, a light beam is directed from one fiber to another with some sort of mechanism. Typical mechanisms for deflecting the light beams include: opto-mechanical devices, MEMS (micro-electrical mechanical systems), mirrors, liquid crystal materials, electro-optically active polymeric materials and electro-holographic materials. While fully optical switches have the advantage of not requiring a transformation of a signal into a different form in order to be routed through the switch, conventional deflection-based optical switches often have high signal losses and require expensive components and control mechanisms, packaging or costly labor-intensive alignment. In addition, such switches may have high crosstalk, nonuniform attenuation of the signal across the switch, slow switching speeds or bulky form factors.

### SUMMARY OF THE INVENTION

An optical switch according to one embodiment of the present invention includes a plurality of optical modules that switch light between a number of optical fibers. The optical modules include a beam steering mechanism and a processor for controlling the beam steering mechanism to direct light to or from an associated optical fiber. One or more beam detectors provide feedback signals to the processor to align optical modules in the switch. In one embodiment of the invention, the beam steering mechanism comprises movable lenses positioned in front of an optical fiber by piezoelectric motors.

In one embodiment of the invention, the optical modules include a mechanism for defocusing the light from an optical fiber in order to increase the size of the beam when optical fibers in the switch are being aligned.

In one embodiment of the invention, each optical module is individually replaceable in the switch such that the capacity of the switch can be increased or decreased by selectively adding or removing optical modules.

In one embodiment of the invention, the piezoelectric motors that move the lenses in front of an optical fiber include an engagement head that is translated by a pair of piezoelectric elements. The piezoelectric elements are coupled to the engagement head with a conductive adhesive that forms an electrode. Wires or other conductors embedded in the adhesive are connected to driver circuits to deliver driving signals to the piezoelectric elements. The driving signals are preferably modified square waves having less abrupt leading and falling edges.

In accordance with another embodiment of the invention, a piezoelectric motor includes a single engagement head positioned on one side of a moveable member and a low friction bearing positioned opposite the engagement head. In one embodiment, the low friction bearing includes one or more roller bearings that are biased toward the movable member by a spring or other biasing mechanism.

In yet another embodiment of the invention, a piezoelectric motor includes a movable shaft that moves within a frame. The movable shaft engages actuation bars on each side of the movable shaft. Engagement heads driven by piezoelectric elements move the movable shaft with respect to the actuation bars.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 illustrates an environment where optical switches including those of the present invention are used;

FIG. 2 illustrates an N by N optical switch in accordance with one embodiment of the present invention;

FIG. 3 is a functional diagram of an optical module that selectively steers light from one optical fiber to another in accordance with one embodiment of the present invention;

FIG. 4 illustrates various components included within an optical module housing;

FIG. 5 is a block diagram of an optical switch for routing telephone or data signals between optical fibers in accordance with one embodiment of the invention; embodiment of the present invention;

FIG. 7 illustrates a pair of aligned concave forms in which optical module housings can be fitted to create an optical switch;

FIG. 8 illustrates a cabinet for aligning optical module housings in an optical switch according to an embodiment of the present invention;

FIG. 9 illustrates one embodiment of a piezoelectric motor according to the present invention for moving a lens in an optical switch;

FIG. 10 illustrates another embodiment of a piezoelectric motor according to the present invention for moving a lens in an optical switch,

FIG. 11 illustrates yet another embodiment of a piezoelectric motor according to the present invention for moving a lens in an optical switch;

FIGS. 12-14 illustrate yet another embodiment of a piezoelectric motor according to the present invention for moving a lens in an optical switch;

FIG. 15 is a cross-sectional view of an optical module housing in which motors are placed for directing light from the optical fibers; and

FIGS. 16A-16C show alternative drive signals used to move a piezoelectric motor.

### DETAILED DESCRIPTION OF THE PREFERRED EMBODIMENT

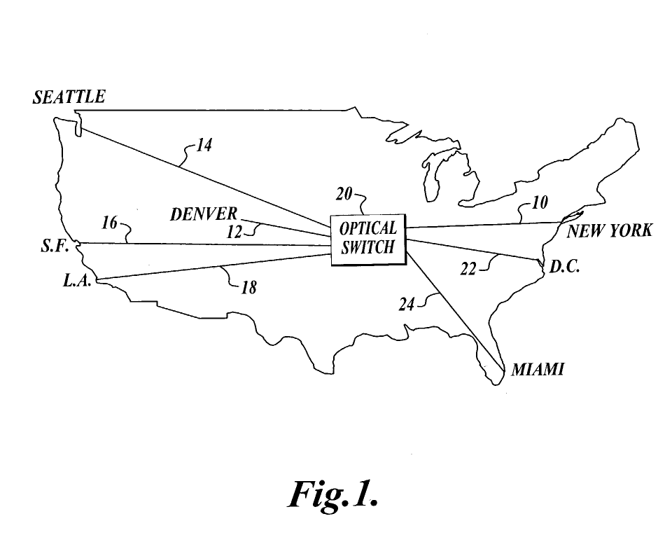

In any communication system, signals need to be routed from one location to another. In a large-scale communication system, such as a nationwide optical telephone or data network, signals are routed to different optical channels by an optical switch. FIG. 1 shows an optical switch 20 that directs signals on an incoming optical fiber, such as the fiber 10, to any one of a number of optical fibers 12, 14, 16, 18, 22, 24, etc. that carry the signals to different parts of the country. For example, optical signals to be routed from New York to Los Angeles may be routed on a channel that includes an optical fiber 10 that is connected to a second optical fiber 20 within the optical switch 20. Although this example depicts a domestic networking application, it will be appreciated that similar networks can extend on a global scale. Furthermore, a data network may have many optical switches for routing signals to their intended destinations.

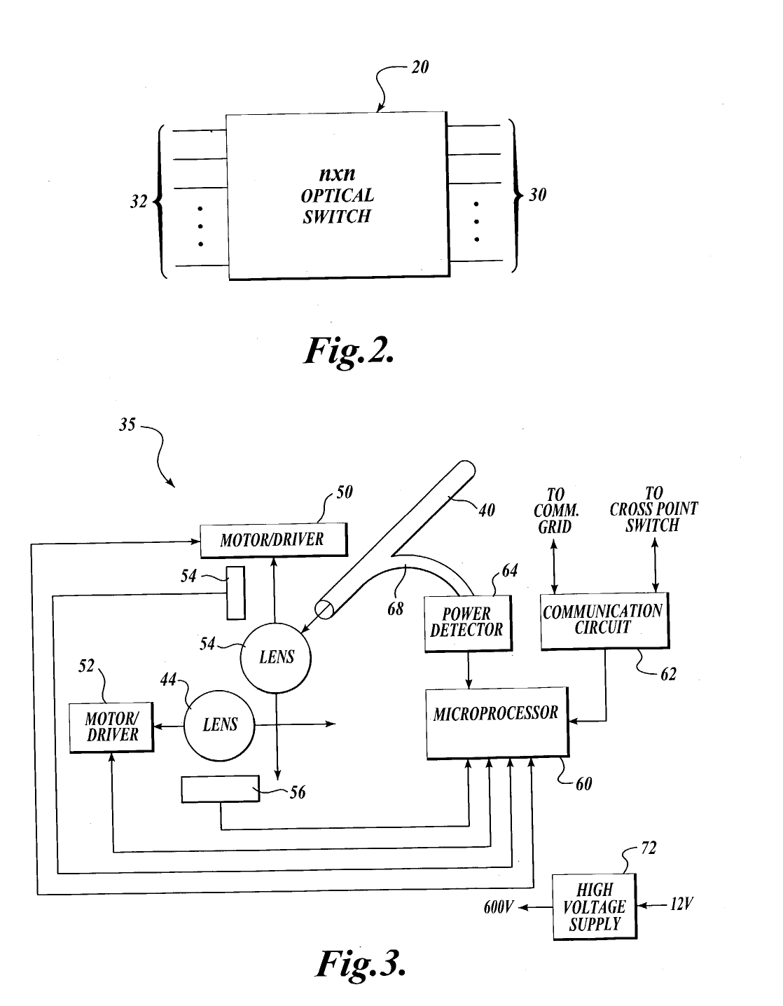

FIG. 2 illustrates an N by N optical switch. The optical switch 20 receives optical signals on a set of N input ports 30 and directs the signals to one of a set of N output ports 32. Light from any of the N input ports 30 may be switched to any of the N output ports 32. Furthermore, the optical switch 20 may be bidirectional such that the input and output ports may be reversed and light on any of the N ports 32 may be switched to any of the N ports 30. Alternatively, light from two or more input ports 30 may be directed to the same output port thereby forming a multiplexer.

Although the optical switch 20 is preferably configured as an N by N optical switch having equal numbers of input and output ports, it will be appreciated that the optical switch 20 may be configured as an N by M switch whereby the numbers of input and output ports are not the same. In addition, as will be explained below, the optical switch of the present invention allows individual optical ports to be added or removed from the optical switch as capacity demands and while the system is in operation carrying live traffic.

In order to switch light from an input port to an output port, the light on an incoming fiber must be deflected to an outgoing fiber in the optical switch. In one embodiment of the invention, the optical switch 20 comprises a number of independent optical modules that steer light between optical fibers.

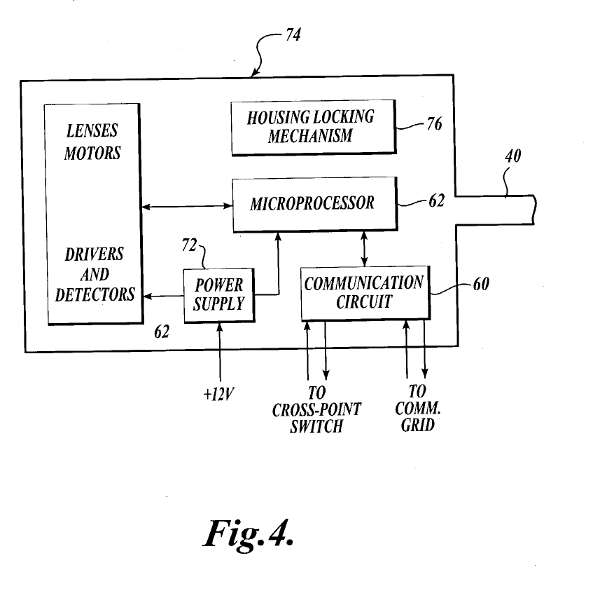

FIG. 3 illustrates the basic components of an optical module 35 in accordance with one embodiment of the present invention. Light to be directed by the optical module 35 is received on an input optical fiber 40 and is selectively steered by the module 35 to an output optical fiber (not shown). The optical module 35 includes a beam steering mechanism such as a pair of lenses 42, 44 that are positioned in front of the input optical fiber 40 in order to direct light from the fiber in the desired direction. Each of the lenses 42, 44 operates to move the light within an arc depending on the position of the lens with respect to the end of the fiber 40. The lenses 42 and 44 are preferably positioned so that the arcs in which light is deflected are orthogonal to each other such that light passing through both lenses can be deflected in any desired direction. In one embodiment of the invention, the lenses 42 and 44 are GRIN lenses. However, other types of lenses such as aspheric, double convex, plano convex, achromatic, meniscus, holographic, Fresnel or a combination thereof could be used to steer light from one fiber to another.

The position of lens 42 is selectively controlled by a motor and driver circuit 50. Similarly, the position of lens 44 is selectively controlled by a motor and driver circuit 52. Each of the motors and driver circuits 50 and 52 is controlled by a microprocessor 60. The microprocessor 60 receives signals from a communication circuit 62 that in turn receives data indicating the identity or position of an optical module that is to receive the light from the optical fiber 40. Upon receiving the identity or position of the desired optical module, the microprocessor controls the motors and driver circuits 50, 52 such that the lenses 40, 42 are positioned in front of the optical fiber 40 to deflect the light in the desired direction. Associated with each motor and driver circuit 50, 52 are a position sensor 54, 56 that operates to sense the position of the motors. Such position sensors 54, 56 may be optically or electrically based and provide signals to the microprocessor 60 to accurately position the motors.

The optical module 35 may also include one or more detectors 64, that detect the optical power in each optical fiber 40. A tap 68 directs a portion of the light in the optical fiber 40 to the one or more detectors 64. The one or more detectors 64 is connected to the microprocessor 60 so that the microprocessor can analyze the power of the light received by the optical fiber 40. Based on the optical power or other parameters detected, the microprocessor 60 adjusts the position of one or both of the lenses 42, 44 to maximize the optical power received or may transmit the data concerning the received optical power to another optical module in order to adjust the lens positions at the other optical module. The one or more detectors 64 in combination with the microprocessor 60 form a control circuit that refines the position of the lenses when the optical fiber 40 receives light from another optical fiber. A number of different control algorithms may be employed to achieve this alignment.

The optical module 35 also includes a high voltage power supply 72 that converts a lower voltage supplied to each optical module to the higher voltages (e.g. 600 volts) required to operate the motors and driver circuits 50, 52.

In one embodiment of the invention, each optical module 35 is preferably a self-contained unit that operates to align two or more optical fibers in the switch. Each module therefore can be considered as a “smart module” that has onboard processing power and a beam steering mechanism that allow the optical module to function somewhat independently of a system controller for the entire switch. In addition, each optical module is preferably contained within an optical module housing that can be inserted or removed from the optical switch without interfering with the operation of the other optical modules.

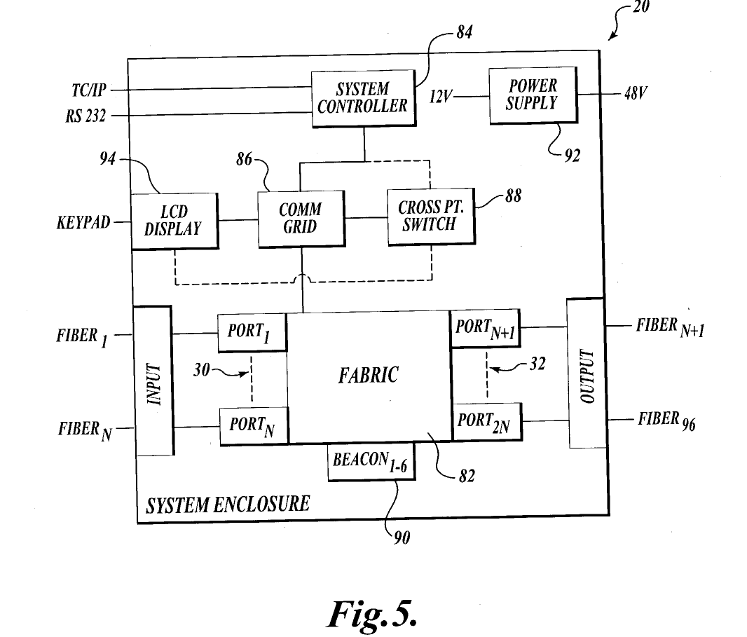

FIG. 4 illustrates the components of a single optical module housing 74. Within the housing 74 are the lenses, motors, drivers and detector, the microprocessor 60, and the power supply 72 that control the position of the lenses and motors as described above. The optical module housing also includes the communication circuit 62 (which may be integrated within the microprocessor) that receives communication signals that inform the optical module where the light from the optical fiber 40 should be directed. Finally; the optical housing 74 includes a housing locking mechanism 76 that allows the optical module housing 74 to be selectively secured within the optical switch. The housing locking mechanism 76 is preferably a low insertion force type that allows the port to be removed, inserted and secured without impacting the position or performance of neighboring optical modules. One embodiment is a twist and lock structure that mates with a corresponding structure on a switch cabinet. Alternatively, the locking mechanism 76 can include a spring loaded detent mechanism, such that the optical module housing 74 can be inserted or removed from the optical switch without the use of tools or without disturbing the other modules in the switch.

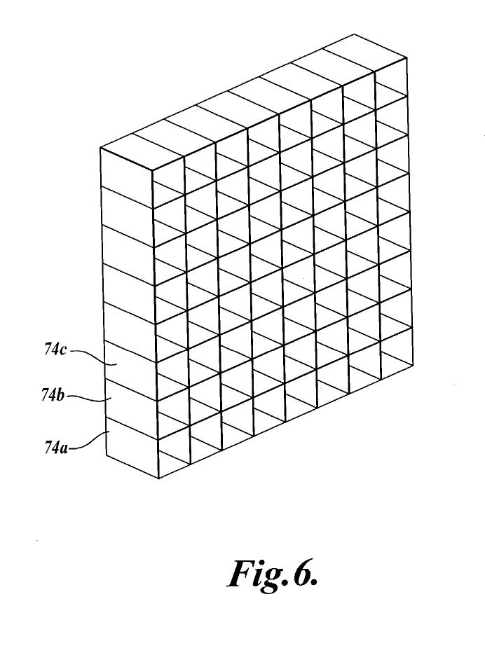

FIG. 5 illustrates the major components of an optical switch 20 in accordance with one embodiment of the present invention. The switch 20 includes a fabric or a frame 82 into which the optical module housings for the number of input ports 30 and output ports 32 are placed. A system controller 84 controls the operation of the switch. The system controller 84 receives signals on a communication link such as a TCP/IP connection or an RS232 connection that indicate the desired alignment of the input and output optical channels.

The system controller 84 is in communication with a communications grid 86. The communications grid 86 receives an indication from the system controller 84 of the input and output optical modules that are to be aligned in the switch. Upon receiving an indication from the system controller 84 that two optical modules are to be realigned, the communication grid sends a message to the communication circuits of the optical modules that indicates they should align themselves. In addition, the communication grid 86 sends a message to a cross-point switch 88 that causes the cross-point switch to create a dedicated communication link between the input and output optical modules to be aligned so they can send messages back and forth regarding their optical fiber alignment in order to maximize the optical power transfer.

The cross-point switch 88 allows messages to be transmitted between aligned optical modules without the need to share a common bus with other modules or components in the system. Therefore, communications bandwidth requirements are reduced, since there is no competition with other ports for communications time. In addition, processing speed is increased because the system controller 84 does not need to arbitrate who can use a common communication link at any given time. Furthermore, such an arrangement allows the optical modules to operate independently and to align themselves without further input from the system controller 84.

The one embodiment of the invention, the communication grid 86 and cross-point switch 88 are field programmable gate arrays that have the same configuration so that each can perform the tasks of the other. Therefore, if the communication grid 86 fails, the system controller 84 can communicate with the cross-point switch 88 and use it to direct messages to the individual optical modules until the communication grid 86 is repaired. Similarly, the communication grid 86 can establish a dedicated communication link between optical modules in the event the cross-point switch 88 fails.

The optical switch 20 also includes a number of beacons 90 that are preferably LED's, laser diodes, or other light sources positioned on the fabric 82. The beacons 90 produce optical signals that can be detected by each of the optical modules. Each beacon transmits a feedback controlled light signal that is the same as or can be differentiated from the light signals of the other beacons. In addition, each beacon 90 is positioned at a known location in the fabric 82. When an optical module is first constructed. it is calibrated with the position sensors 54, 56. The optical module is given its location in the optical switch so that it can be roughly calibrated. The module then detects how it receives light from one or more of the beacons 90, in order to fine tune its calibration. When two optical modes are assigned to align the light from their optical fibers, the optical modules may exchange their positions as determined from the beacons in order to roughly align their fibers. Once the optical modules are roughly aligned, the optical modules exchange messages through the communication link set up in the cross-point switch 88 in order to maximize the optical power in the optical fibers.

In addition to the components discussed above, the optical switch 20 also includes a power supply 92 that supplies each optical module in the switch module with a relatively low voltage such as 12 volts. An LCD liquid crystal display and keypad 94 allow a system operator to alter the operation or configuration of the optical switch 20 if desired.

In some instances, it may be beneficial to move the optical fiber with respect to the lenses during the initial aligning of the light beams. Moving the fiber axially with respect to the lenses causes the cone of light created by the lenses to expand or narrow. In order to ease alignment of two optical modules in the fabric, the cone of light from the transmitting fiber may be expanded. Once an initial alignment has been made, the position of the optical fiber is adjusted with respect to the lenses to narrow the light beam and concentrate the optical power. To move the fiber with respect to the lenses, the fiber is mounted on a movable member within the optical module such as on a linear motor, screw mount or other mechanism that is controlled by the microprocessor to precisely adjust the position of the optical fiber with respect to the lenses.

As indicated above, one advantage of having each optical module be self-contained is that the size of the optical switch can be varied by selectively adding or removing optical modules from the switch. The switch may include a fabric or frame into which the optical module housings are inserted or removed. Alternatively, as shown in FIG. 6, a number of optical module housings 74a, 74b, 74c, etc., can be connected directly to each other in order to build up a switch matrix of the desired size and shape. In the optical switch shown in FIG. 6, each optical module housing 74a, 74b, 74c, etc., has an interlocking mechanism on the outside of the housing which allows it to connect to adjacent modules in order to build up the matrix of the desired size. It is preferable that the interlocking mechanisms be designed such that an individual housing module can be inserted or removed from the matrix without disturbing the other optical module housings. This can be useful not only in changing the size of the matrix but also for repair. One optical module housing can therefore be removed from the matrix and replaced without having to replace all the other modules in the switch or without having to shut the other modules down when repairs or upgrades to a single module need to be made.

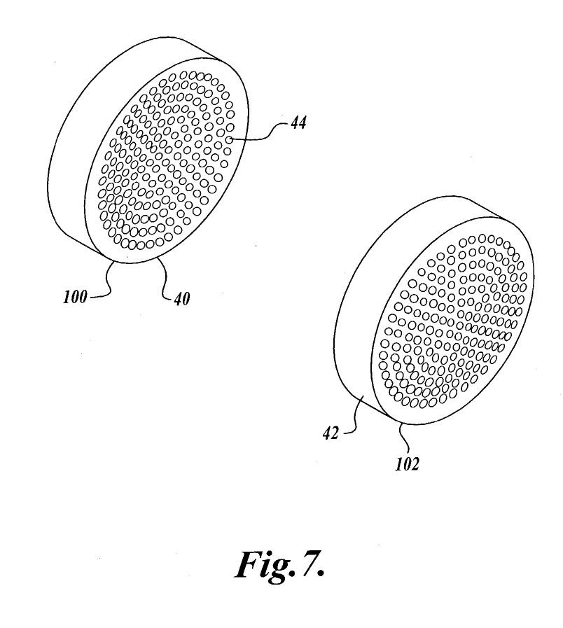

FIG. 7 shows another embodiment of an optical switch for aligning optical modules. The optical switch includes two forms 100, 102 in which the individual optical module housings are inserted. The forms 100, 102 nave opposing concave surfaces that decrease the differences in optical path length and angular distance between opposing input and output optical ports. In addition, the forms 100, 102 have convex rear surfaces that increase the distance between adjacent optical module housings in order to facilitate the insertion or removal of an optical module housing from the form.

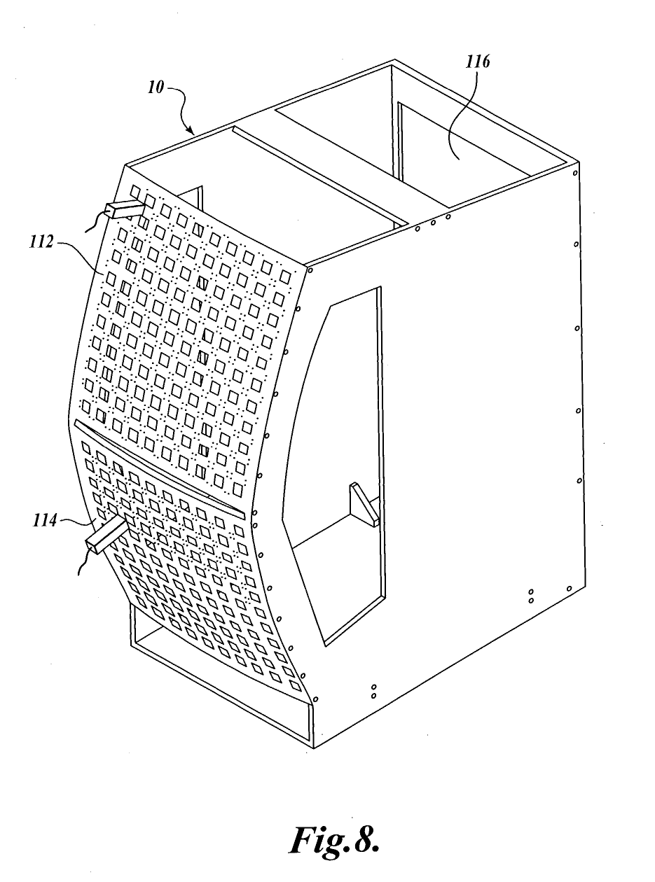

FIG. 8 shows a cabinet 110 of an optical switch including a pair of fabrics 112, 114 having a number of holes or slots into which individual optical module housings can be inserted. In one embodiment, the fabrics 112, 114 have a concave inner surface and a convex outer surface in order to reduce the angular distance between input and output modules to be aligned in the switch. The convex rear surface of the fabrics 112, 114 operates to increase the distance between adjacent optical housing modules. Each fabric 112, 114 is oriented towards a mirror 116. Light from an input optical module is reflected by the mirror 116 towards the desired output optical module. The mirror 116 operates to reduce overall the size of the cabinet 110 but may be omitted if desired.

The optical switch allows optical modules to be added as increased capacity is desired. To add a module to the switch, the optical module housing is inserted into the fabric and power and communication connections are made to the system controller, as described above. The ability to selectively add capacity to the switch makes it possible to expand the capacity of each switch during operation in the field, allowing system vendors and network providers to upgrade the switch capacity without interruptions to network service. Therefore, users can minimize their initial capital investment while preserving the ability to grow switch capacity up to the number of ports that can be accommodated by the fabric.

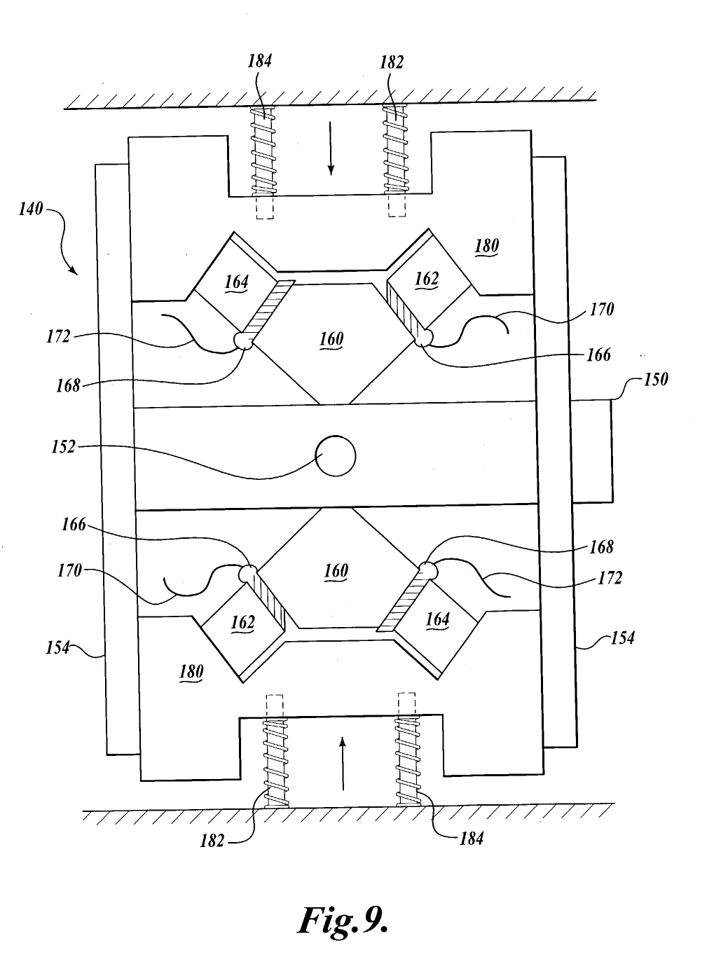

As indicated above, each of the lenses that is positioned in front of the optical fibers is moved by one or more motors. FIG. 9 shows one embodiment of a piezoelectric motor 140 adapted to move a lens in an optical module. The piezoelectric motor 140 moves a workpiece such as a movable bar 150 having an aperture 152 into which the lens (not shown) is placed. Driving elements on each side of the bar 150 cause the bar 150 to move backwards and forwards within a frame 154. The bar 150 is marked with a scale that is read by optical position sensors or may include other sensing mechanisms that allow the position of the bar to be accurately determined.

To move the bar 150, the driving elements include a pair of oppositely facing engagement heads 160 on either side of the bar. Each engagement head 160 is made of a ceramic or other material that can be selectively translated by pairs of piezoelectric elements 162, 164 associated with each engagement head 160. The piezoelectric elements support the engagement head against the movable bar 150. An electrode 166 is positioned between the engagement head 160 and the piezoelectric element 162. Similarly, an electrode 168 is positioned between the engagement head 160 and the piezoelectric element 164. Each of the electrodes 166, 168 is preferably formed of a conductor 170, 172 embedded in one or more sheets of conductive epoxy such as Ablefilm CF 3350, available from Emerson & Cuming.

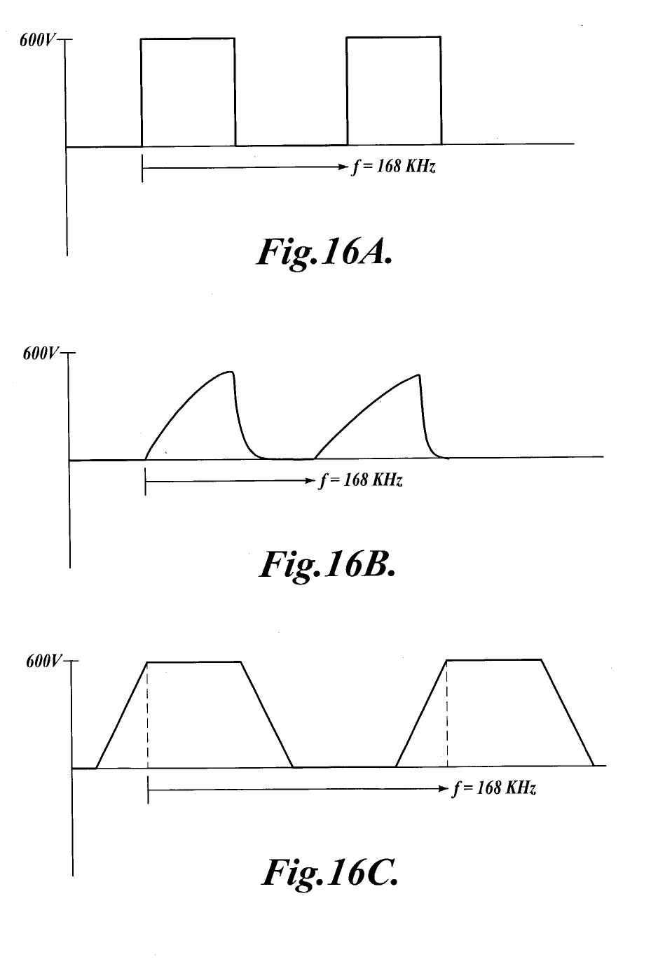

The motor control circuits apply driving signals to the piezoelectric elements 162, 164 thereby causing the engagement head 160 to translate and move the bar 150 in the desired direction. In most piezoelectric motors, the driving signals applied to the piezoelectric elements are square waves as shown in FIG. 16A. However, it has been determined that such square waves may contribute to motor failure if directly applied to the piezoelectric elements. Therefore, the present invention preferably uses a modified square wave by placing a resistance in line with the piezoelectric elements in order to smooth out the sharp transitions of the square wave driving signals as shown in FIG. 16B. In yet another embodiment, it has been found that ramp signals of the type shown in FIG. 16C are optimal for driving the piezoelectric elements. Such ramp signals can be created by selectively turning on the FETS in the drive circuits and current limiting or other techniques used in waveform creation known to those skilled in the art.

The other sides of the piezoelectric elements 160, 162 are secured to an insulating layer, such as a sheet of epoxy adhesive, that in turn is connected to a conductive countermass 180. The conductive countermass 180 is biased toward the movable bar 150 by a pair of biasing mechanisms such as springs 182, 184 that are mounted over rods or other guide mechanisms. The springs have their other end fixed to the frame 154 or other fixed point to urge the conductive countermass 180 and the engagement head 160 against the movable bar 150. The frequency of the driving signals applied to the piezoelectric elements is dictated by the vibrational mode-shape that produces elliptical motion on the engagement head. Factors contributing to the mode frequencies are the mass, stiffness and geometry of the motor system.

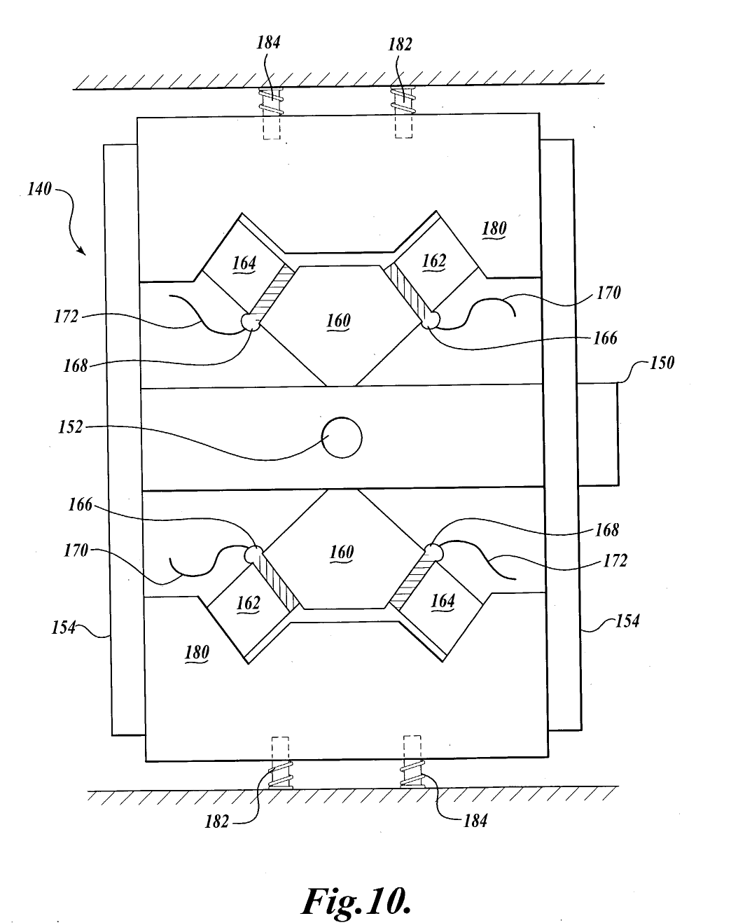

FIG. 10 shows an alternative embodiment of a piezoelectric motor 190 in accordance with another embodiment of the invention. The motor 190 has generally the same configuration as the motor shown in FIG. 9. However, the biasing mechanisms 182, 184 are mounted to a flat surface of a conductive countermass 181 instead of being positioned in a notch or recess. The biasing members 182, 184 urge the countermass 181 and engagement heads 160 against the movable bar 150.

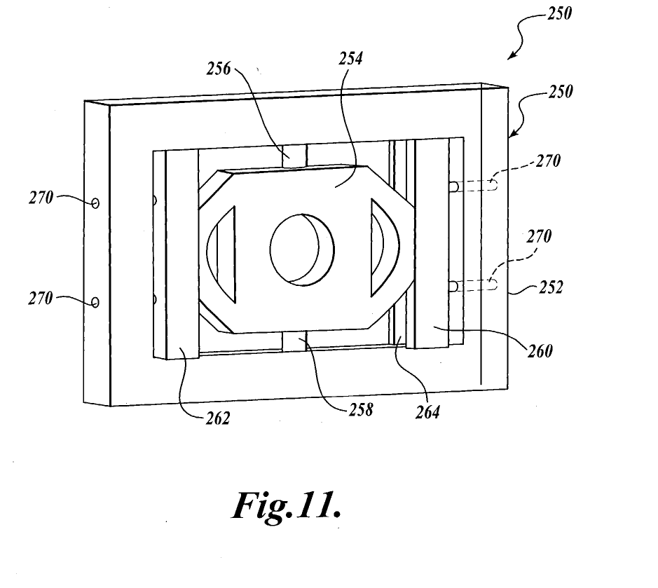

FIG. 11 shows yet another alternative embodiment of a motor 250 for selectively moving a lens in the optical module. The motor 250 includes a frame 252 that surrounds a self-moving shaft 254. The self-moving shaft 254 moves up and down within the frame on a pair of alignment pins 256, 258 positioned on either side of the self-moving shaft 254. Positioned within the frame on either side of the self-moving shaft 254 is a pair of actuation surfaces 260, 262. Each actuation surface has a slot 264 into which the edge of the self-moving shaft 254 is fitted. Each edge of the self-moving shaft 254 that is fitted within the slot 264 has an engagement head. Piezoelectric elements couple the self-moving shaft to the engagement head. The piezoelectric elements cause the engagement heads to vibrate, thereby causing the self moving shaft to move on the alignment pins 256, 258 and in the slots of the actuation bars. Springs or other biasing mechanisms 270 cause the actuation surfaces 260, 262 to be biased towards the self-moving shaft 254. A lens (not shown) is placed in the self-moving shaft. The lens is positioned by the application of the appropriate driving signals to the piezoelectric elements on the self-moving shaft.

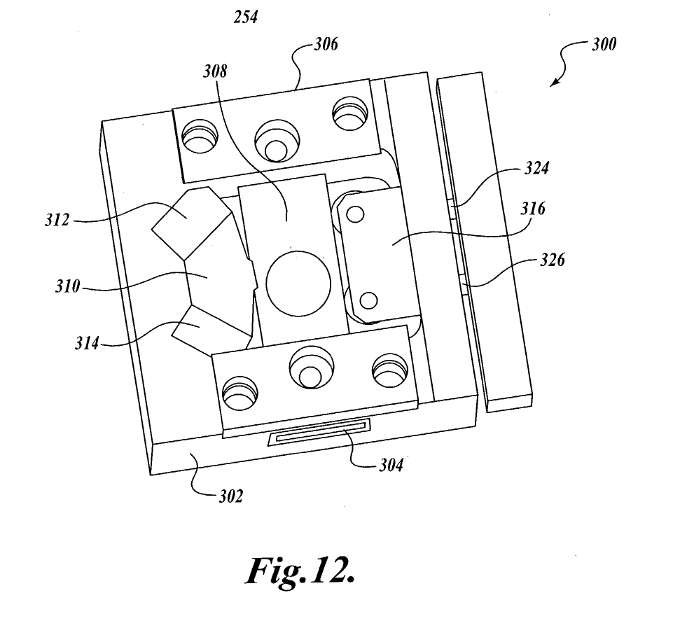

FIG. 12 shows yet another alternative embodiment of a piezoelectric motor 300 in accordance with the present invention. The motor 300 includes a frame 302 that surrounds the motor. The frame has a pair of slots 304, 306 through which a movable bar 308 can extend. The movable bar 308 has an aperture into which a lens (not shown) is placed.

Unlike the previously described motor designs that have included a pair of oppositely opposed engagement heads, the motor 300 includes a single ceramic engagement head 310 that is moved by a pair of piezoelectric elements 312, 314. The piezoelectric elements have one side coupled to the frame 302 and the other side coupled to the engagement head 310. Opposing the engagement head 310 on the other side of the movable bar is a low friction-bearing surface. In one embodiment, a pair of roller bearings 316 engages the movable bar 308. However, other low friction members could be used such as Teflon™ coated members etc.

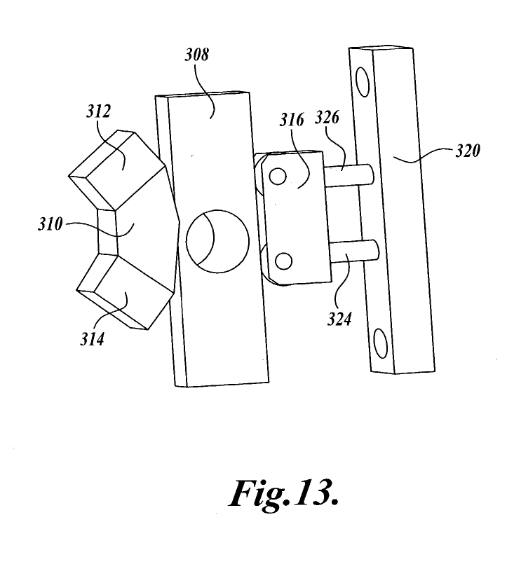

The roller bearings 316 are coupled to a rigid premass 320 and may be biased toward the sliding movable bar 308 by biasing members such as springs 324, 326 disposed between the roller bearings 316 and the rigid premass 320. As shown in FIG. 13, the ceramic engagement head 310 is moved by the piezoelectric elements 312, 314 to urge the movable bar 308 in and out of the slots 304, 306 in the frame.

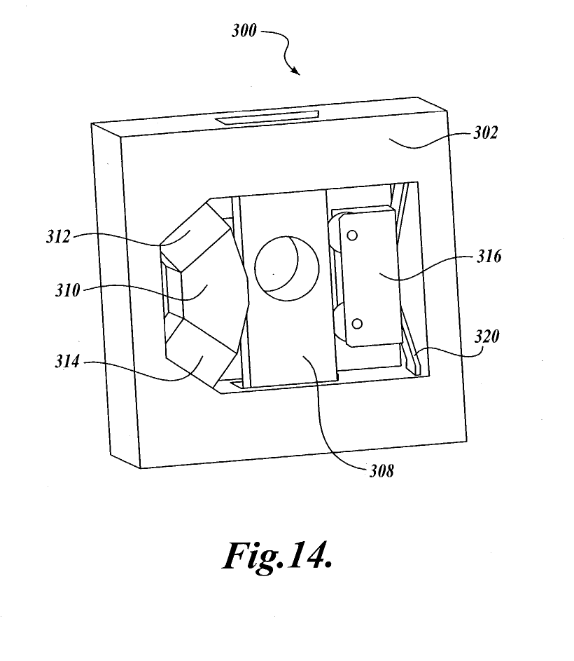

FIG. 14 shows a leaf spring assembly 320 positioned between the frame 302 and the roller bearing 316 for urging the roller bearing 316 against the movable bar 308. In this embodiment, the frame 302 acts on a rigid premass. Besides springs, it will be appreciated that other mechanisms may be used to urge the roller bearing 316 or other low friction member against the movable bar including magnetic, pneumatic, hydraulic, or other forces.

In one embodiment of the invention, the movable bar is coupled to a mechanical slide (not shown) available from IKO Company of Japan and the engagement head 310 is biased toward the movable bar by one or more springs.

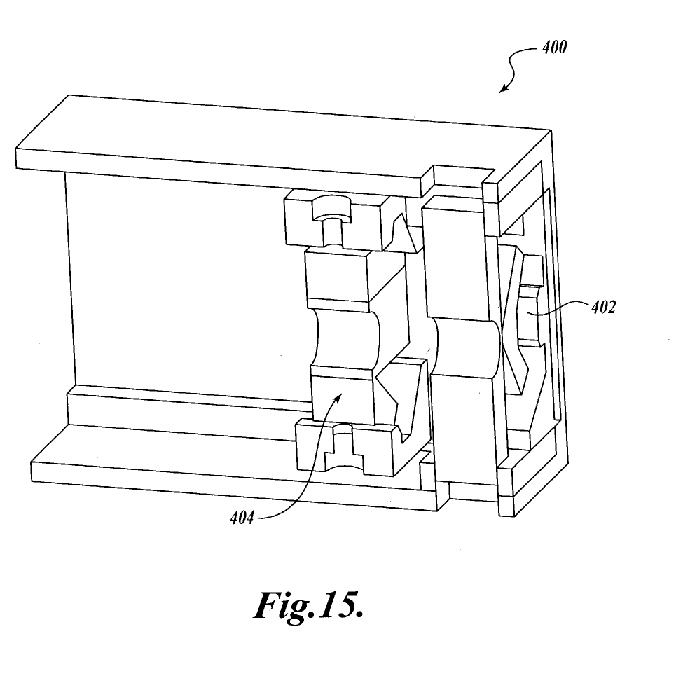

Turning now to FIG. 15, an optical module housing 400 includes a pair of motors 402, 404 positioned to move a pair of lenses in front of an optical fiber. Each motor lens is positioned to move the lens in a direction that is orthogonal to the directional movement created by the other motor. Each optical module housing also includes a mount for positioning an optical fiber behind the lenses. As discussed above, the mount may be movable to defocus the light beam in order to aid beam capture.

While the preferred embodiment of the invention has been illustrated and described, it will be appreciated that various changes can be made therein without departing from the scope of the invention. For example, instead of moving one or more lenses in front of the optical fiber, each optical module can include mechanisms for positioning the fiber with respect to one or more fixed lenses. Alternatively, the fiber and lens structures may be coupled together and gimballed in order to steer the light beam as disclosed in U.S. patent application Ser. No. 09/938,865, assigned to Bainbridge Networks, Inc., the assignee of the present invention and which is herein incorporated by reference. In addition, other beam directing mechanisms such as voice coils, micromachined actuators, thermal, electrostatic or magnetic actuators could be used to direct light out of/into the optical fibers. Therefore, the scope of the invention is to be determined from the following claims and equivalents thereof.

The embodiments of the invention in which an exclusive property or privilege is claimed are defined as follows:

1. An optical switch, comprising:
a number of optical fibers for transmitting or receiving optical telephone or data signals;
a number of optical modules, each of which is associated with an optical fiber, each optical module including a-processor, an optical power detector and a beam steering mechanism for controlling the direction of light transmitted or received by the associated optical fiber;
a frame having a number of slots, each slot holding an optical module; and
a system controller for transmitting data to the optical modules that causes the processors in selected optical modules to align their associated optical fibers.

2. The optical switch of claim 1, wherein the capacity of the switch can be altered in service by-adding optical modules to or removing optical modules from the frame without disturbing the optical signals transmitted by other modules.

3. The optical switch of claim 1, wherein processors of selected optical modules exchange alignment messages regarding alignment of their optical fibers.

4. The optical switch of claim 3, further comprising a cross-point switch for establishing a communication link between selected optical modules,
wherein said alignment messages transmitted between the selected optical modules are carried by the cross-point switch.

5. The optical switch of claim 1, wherein the beam steering mechanism comprises one or more lenses selectively positioned in front of the associated optical fiber to direct the light transmitted or received by the optical fiber.

6. The optical switch of claim 5, wherein the one or more lenses are positioned by the piezoelectric motors.

7. The optical switch of claim 3, wherein the optical the power detector produces signals indicative of the power of the light within the associated optical fiber wherein the signals are exchanged between selected optical modules as alignment messages.

8. An optical switch, comprising:
a number of optical fibers that carry data signals;
a system controller that arranges the alignment of input and output optical fibers in the switch;
a number of optical modules, each of which directs light to or from an optical fiber, each optical module including:
one or more lenses that are movable in front of an optical fiber to direct light to or from the optical fiber;
one or more motors that move the one or more lenses;
a processor for controlling the position of the one or more motors;
a communication circuit for receiving an indication of a second optical module in the switch to which light from the optical fiber is to be directed; and
a frame in which a number of optical modules are removably secured, wherein the processor in the optical module controls the one or more motors to align the optical fiber in the optical module with an optical fiber in a second optical module.

9. The optical switch of claim 8, further comprising;
a cross-point switch for establishing a dedicated communication link between aligned optical modules in the switch.

10. The optical switch of claim 8, wherein each of the optical modules is secured to the frame with a removable locking mechanism.

11. The optical switch of claim 9, further comprising a communications grid that transmits messages to each of the optical modules indicating which optical modules should be aligned.

12. The optical switch of claim 1, wherein the optical switch and the cross-point switch are interchangeable in the switch.

13. The optical switch of claim 8, wherein each optical module includes a power detector that detects the power of the optical signals within the optical fiber.

14. A piezoelectric motor for moving a workpiece, comprising:
an engagement head that engages the workpiece;
a pair of piezoelectric elements coupled to the engagement head;
a pair of electrodes that couple the piezoelectric elements to the engagement head, the pair of electrodes being formed of conductors within a conductive adhesive;
a countermass secured to the piezoelectric elements; and
a biasing mechanism for compressing the engagement head and the workpiece together.

15. The piezoelectric motor of claim 14, wherein the pair of piezoelectric elements are driven by a modified square wave signal.

16. The piezoelectric motor of claim 14, wherein the pair of piezoelectric elements are driven by ramp signals.

17. The piezoelectric motor of claim 14, further comprising a second engagement head positioned opposite the first engagement head on the workpiece.

18. The piezoelectric motor of claim 14, wherein the biasing mechanism includes a roller bearing positioned opposite the engagement head on the workpiece and a spring that urges the roller bearing against the workpiece.

19. The piezoelectric motor of claim 14, wherein the workpiece is secured to a linear slide.

20. A piezoelectric motor for moving a workpiece, comprising:
a frame;
a movable shaft that moves within the frame, the movable shaft having a pair of engagement heads that are translated by piezoelectric elements to move the movable shaft;
a pair of actuation surfaces that engage against the engagement heads of the movable shaft; and
a drive circuit that supplies driving signals to the piezoelectric elements to move the movable shaft while the actuation surfaces remain stationary in the frame.

21. The piezoelectric motor of claim 20, wherein the actuation surfaces have a slot in which the engagement heads are fitted.

22. The piezoelectric motor of claim 20, wherein the actuation surfaces are biased against the engagement heads.

23. A fiber optic switch, comprising:
a number of optical modules each of which directs light to and from an optical fiber, each module including:
an optical fiber;
a beam steering mechanism for directing light from or into the optical fiber; and
a control circuit that directs the beam steering mechanism to align light beams from two or more optical fibers.
a frame into which the optical modules are removably secured; and
a system controller for transmitting to the optical modules the identity and/or location of optical modules in the switch that should be aligned.

24. The optical switch of claim 23, further comprising:
a number of beacons that transmit signals to the optical modules, wherein the position of each beacon is known such that upon receipt of one or more of the signals, each optical module can calibrate itself in the frame.

25. The optical switch of claim 23, wherein at least some of the modules include an optical fiber moving mechanism for adjusting the position of the optical fiber with respect to the beam steering mechanism in order to defocus the beam.

26. The optical switch of claim 25, wherein the beam steering mechanism includes one or more lenses selectively positioned in front of the optical fiber in the optical module, wherein the fiber moving mechanism moves the optical fiber with respect to the one or more lenses.

27. An optical switch comprising:
a number of input and output optical fibers;
a number of optical modules for selectively aligning input and output optical fibers in the optical switch, each optical module including;
an optical fiber;
a beam steering mechanism;
a communication circuit for communicating with other optical modules;
a control circuit for aligning optical fibers in the switch; and
a fiber moving mechanism for moving the optical fiber with respect to the beam steering mechanism in order to increase the area of light created by the beam when the optical fibers are being aligned.

28. An optical switch, comprising:
a number of optical fibers for transmitting or receiving optical telephone or data signals;
a number of optical modules, each of which is associated with an optical fiber, each optical module including:
a beam steering mechanism for controlling the direction of light transmitted or received by an optical fiber
a processor and power detection circuit that form a control circuit to control the beam steering mechanism in order to align two or more optical fibers; and
a communication circuit for transmitting/receiving messages with a processor in another optical module;
a system controller for transmitting data to the optical modules that causes the processors in selected optical modules to align their associated optical fibers, wherein said alignment is completed by the processors in the optical modules using the power detection circuits to determine the power of light within an optical fiber.

29. The optical switch of claim 28, further comprising:
a cross-point switch for creating a communication link between optical modules associated with optical fibers that are to be aligned.

30. The optical switch of claim 28, further comprising:
a communications grid coupled to the system controller for transmitting messages from the system controller to the optical modules.

31. The optical switch of claim 30, wherein the cross-point switch and the communications grid can perform the functions of the other in the event one of the cross-point switch or communications grid fails.

32. The optical switch of claim 31, wherein the cross-point switch and communications grid are made of field programmable gate arrays.

33. An optical switch, comprising:
a number of optical fibers for transmitting or receiving optical telephone or data signals;
a number of optical modules, each of which is associated with an optical fiber, each optical module including:
means for directing light transmitted or received by an optical fiber
means for controlling the light directing means in order to align two or more optical fibers in the optical switch; and
means for transmitting messages with a controller means in another optical module, wherein said messages are used by the controller means for aligning the optical fibers in the optical switch;
a system controller for transmitting switch configuration data to the optical modules to align their associated optical fibers.
